(19) United States
(12) Patent Application Publication
(10) Pub. No.: US 2009/0147144 A1
(43) Pub. Date: Jun. 11, 2009

(54) TELEVISION BOX

(75) Inventors: Chun-Kai Chan, Taipei (TW); Shin-Pin Lo, Taipei (TW); Li-Hsiang Liao, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: ASUSTEK COMPUTER INC., Taipei (TW)

(21) Appl. No.: 12/236,472

(22) Filed: Sep. 23, 2008

(30) Foreign Application Priority Data
Dec. 7, 2007 (TW) 96146912

(51) Int. Cl. H04N 5/38

(52) U.S. Cl. 348/723; 348/E05.093

(57) ABSTRACT

A television box suitable for being coupled to a display is provided. The television box includes a chip and a transmitter. The chip supports to output a low voltage differential signal. The transmitter is coupled to the chip and selectively transmits the low voltage differential signal output by the chip to a digital visual signal or an analog visual signal. The television box has the advantages of noise reduction and color enhancement.

### CROSS-REFERENCE TO RELATED APPLICATION

This application claims the priority benefit of Taiwan application serial no. 96146912, filed on Dec. 7, 2007. The entirety of the above-mentioned patent application is hereby incorporated by reference herein and made a part of this specification.

### BACKGROUND OF THE INVENTION

1. Field of the Invention

The present invention relates to a television box, in particular, to a television box suitable for reducing noises and enhancing the color.

2. Description of Related Art

With the rapid development of technology in recent years, the mass can watch television programs merely through using a television box/card to be randomly matched with a display, instead of a television set.

Generally, liquid crystal displays (LCDs) are applied to common computers and LCD TVs. Since an LCD screen of the common computer usually has a relatively small size and specific specification settings, television boxes available on the market for the LCD screens of the common computer are not as desirable as those built in the LCD TVs in terms of specifications and grades. Particularly, the television box of the LCD TV is configured with a digital signal interface, so the signal quality is better, such that an image quality of the LCD TV is better than those of the LCD screen. However, the television box matched with the LCD screen is configured with an analog signal interface, so that the problem of noises easily occurs on the images viewed by a user from the LCD screen, and the image quality is relatively poor.

### SUMMARY OF THE INVENTION

Accordingly, the present invention is directed to a television box, suitable for reducing noises and enhancing colors of a display.

The present invention provides a television box, suitable for being coupled to a display. The television box includes a chip and a transmitter. The chip supports to output a low voltage differential signal (LVDS). The transmitter is coupled to the chip and selectively converts the LVDS output by the chip to a digital visual signal or an analog visual signal.

In an embodiment of the present invention, the transmitter is further coupled to the display, such that the digital visual signal or the analog visual signal is input to the display.

In an embodiment of the present invention, the digital visual signal is output to the display via a digital visual interface (DVI).

In an embodiment of the present invention, the analog visual signal is output to the display via a D-subminiature (D-Sub) interface.

In an embodiment of the present invention, the television box further includes a switching device coupled to the transmitter, in which the switching device is used to selectively convert the LVDS output by the chip to the digital visual signal or the analog visual signal.

In the television box of the present invention, the transmitter is used to convert the LVDS to the digital visual signal or the analog visual signal and output the digital visual signal or the analog visual signal. Therefore, through matching with the television box of the present invention, the display enables the user to enjoy images with higher quality.

In order to make the above features and advantages of the present invention comprehensible, a detailed description is given below through the embodiments and accompanying drawings.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of a television box according to an embodiment of the present invention.

FIG. 2A is a schematic view of a DVI.

FIG. 2B is a schematic view of a D-Sub interface.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

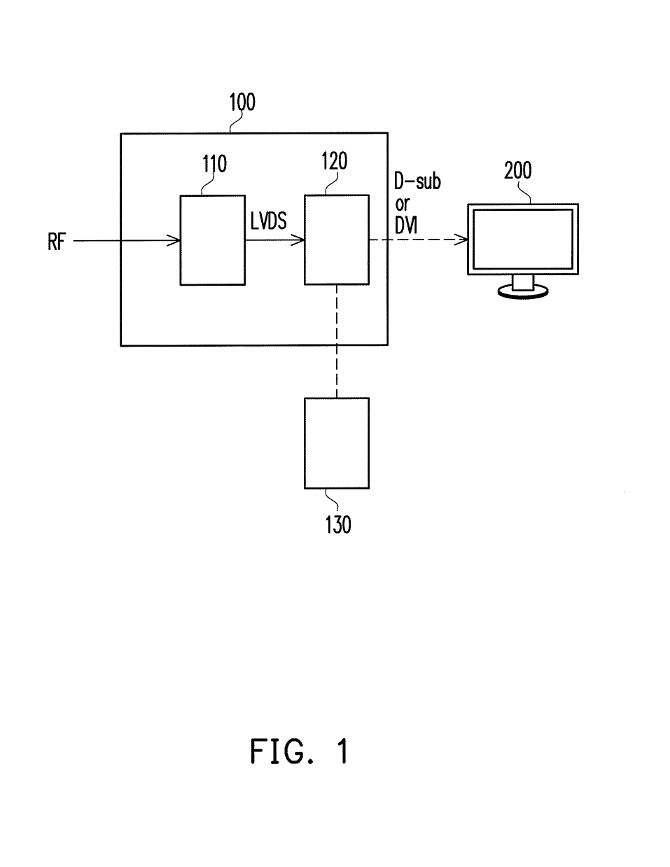

FIG. 1 is a schematic view of a television box according to an embodiment of the present invention. Referring to FIG. 1, a television box 100 is suitable for being coupled to a display 200, in which the display 200 is a desktop LCD screen or a LCD screen of a notebook computer, which has a relative small size.

The television box 100 includes a chip 110 and a transmitter 120 coupled to the chip 110. The chip 110 supports to output a LVDS, and the transmitter 120 coupled to the chip 110 selectively converts the LVDS output by the chip 110 to a digital visual signal or an analog visual signal.

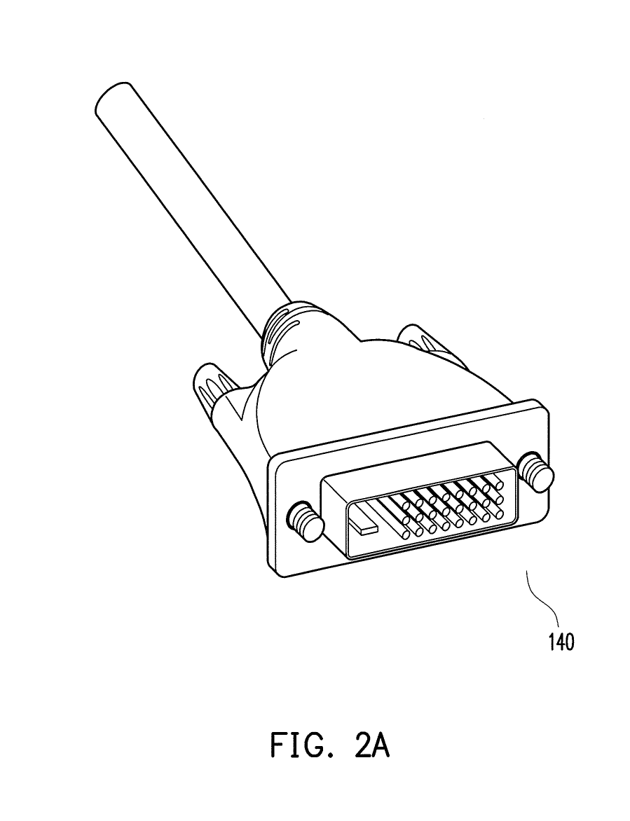

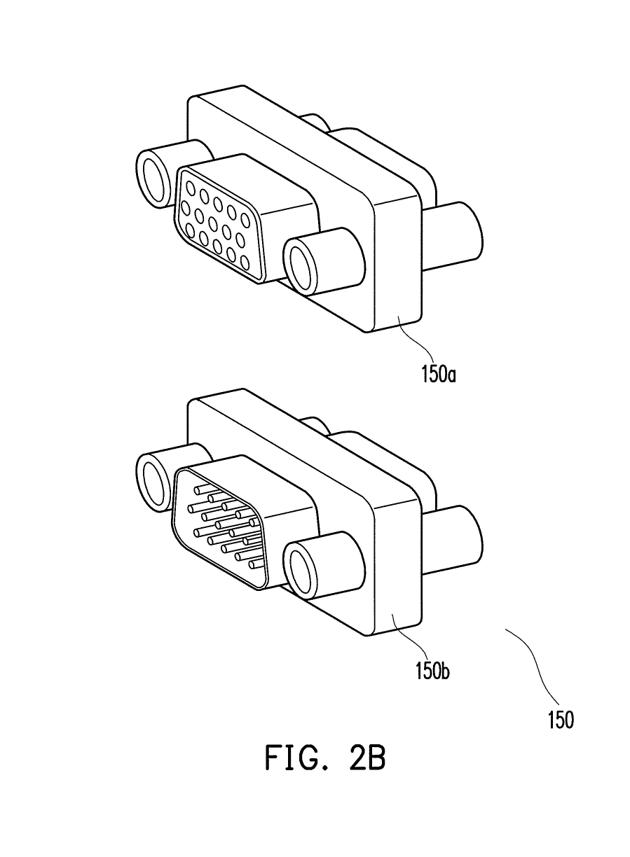

The television box 100 is coupled to the display 200 via the transmitter 120, such that the digital visual signal or the analog visual signal output by the transmitter 120 is input to the display 200. FIG. 2A is a schematic view of a DVI, and FIG. 2B is a schematic view of a D-Sub interface. Referring to FIGS. 2A and 2B, it should be noted that, the transmission interfaces corresponding to the digital visual signal and the analog visual signal are different, so the digital visual signal is output to the display 200 via a DVI 140 in FIG. 2A, and the analog visual signal is output to the display 200 via a D-Sub interface 150 in FIG. 2B. For example, a female connector 150b of the analog signal interface 150 may be installed on the display 200, and the television box 100 is coupled to the display 200 via a cable of a male connector 150a of the analog signal interface 150. The above example is merely intended for demonstration, and those skilled in the art can correspondingly change the positions for disposing the male connector 150a and the female connector 150b of the analog signal interface 150. The manner for disposing the male connector (not shown) or the female connector of the DVI 140 could also be changed according to the demands.

The television box 100 further includes a switching device 130 coupled to the transmitter 120, in which the switching device 130 is used to selectively convert the LVDS output by the chip 110 to the digital visual signal or the analog visual signal. The switching device 130 may be a button or a key directly disposed on the television box 100, and may also be a wireless remote control coupled to the transmitter 120. The user determines to convert the LVDS to the digital visual signal or the analog visual signal via the switching device 130. Alternatively, the switching device 130 is coupled to a detector (not shown), and the detector is used to detect that the television box 100 is coupled to the display 200 via the digital signal interface 140 or the analog signal interface 150, so as to determine to convert the LVDS to the digital visual signal or the analog visual signal.

Referring to FIG. 1, when a radio frequency (RF) signal of the television program enters the television box 100, the chip 110 firstly processes the RF signal into an LVDS and transfers the LVDS to the transmitter 120. In the LVDS specification, two lines in the same group of data lines both have a voltage. When the group of data lines reaches the chip 110 for receiving the data, the chip 110 calculates a voltage difference between the two lines, so as to determine the signal state. In this way, it can prevent the data accuracy from being affected by the poor quality of the cable materials and external interference when the signal is transferred, so as to improve the transmission performance. Therefore, the noise reduction degree of the LVDS is desirable. In addition, in the LVDS specification, three colors of red, blue, and green are separately transmitted, such that the dichroism is more accurate.

As described above, the user may determine the transmitter 120 to convert the LVDS to the digital visual signal or the analog visual signal. When the user intends to enjoy high-quality images, for example, when playing a digital visual disc (DVD), the user may select to convert the LVDS to the analog visual signal. It should be noted that, the LVDS has desirable noise reduction degree and accurate dichroism, so the digital visual signal converted from the LVDS also has a high quality, and the colors of the displaying images of the display 200 are much more beautiful.

When the user does not require the images to have a high quality, he/she may select to convert the LVDS to the analog visual signal and output the analog visual signal to the display 200.

Alternatively, a detector is installed in the television box 100, and the detector automatically detects that the television box 100 is coupled to the display 200 via the digital signal interface 140 or the analog signal interface 150, so as to determine the LVDS to be converted to the digital visual signal or the analog visual signal.

To sum up, the transmitter is disposed in the television box of the present invention to convert the LVDS with a higher quality to the digital visual signal or the analog visual signal, and output the digital visual signal or the analog visual signal to the display. The LVDS has advantages of desirable noise reduction degree and accurate color separation, so the digital visual signal converted from the LVDS by the transmitter also has features of desirable noise reduction degree and accurate dichroism. Therefore, by matching with the television box of the present invention, the display has a high display quality, and the displaying images of the display are much more beautiful.

In addition, there are two selections of the digital visual signal and the analog visual signal when the user using the television box of the present invention. In other words, the user can select the quality of images displayed on the display depending upon different demands, which is quite convenient.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A television box, suitable for being coupled to a display, comprising:
a chip, for supporting to output a low voltage differential signal (LVDS); and
a transmitter, coupled to the chip, for selectively converting the LVDS output by the chip to a digital visual signal or an analog visual signal.

2. The television box according to claim 1, wherein the transmitter is coupled to the display, such that the digital visual signal or the analog visual signal is input to the display.

3. The television box according to claim 1, wherein the digital visual signal is output to the display via a digital visual interface (DVI).

4. The television box according to claim 1, wherein the analog visual signal is output to the display via a D-subminiature (D-Sub) interface.

5. The television box according to claim 1, further comprising a switching device coupled to the transmitter, for selectively converting the LVDS output by the chip to the digital visual signal or the analog visual signal.
